(19) United States
(12) Patent Application Publication
(10) Pub. No.: US 2007/0010234 A1
(43) Pub. Date: Jan. 11, 2007

(54) Method, system, modules and program for associating a callback number with a voice message

(76) Inventors: Axel Chazelas, Paris (FR); Marc Gesbert, Paris (FR); David Meyer, Lyon (FR)

Correspondence Address: YOUNG & THOMPSON, 745 SOUTH 23RD STREET, 2ND FLOOR, ARLINGTON, VA, 22202, US

(21) Appl. No.: 11/478,579

(22) Filed: Jul. 3, 2006

(30) Foreign Application Priority Data
Jul. 5, 2005 (FR) 05 07138

(51) Int. Cl. H04M 3/42

(52) U.S. Cl. 455/417; 455/413

(57) ABSTRACT

A method of associating a callback number with a voice message includes: as the caller speaks the voice message to be recorded, a step of continuous and real-time comparison of the natural language expressions contained in the voice message spoken with one or more predefined expressions, and in case of correspondence between the expression spoken by the caller and the or one of the predefined expressions, a step of acquiring the callback number to be associated with the voice message recorded is immediately triggered.

The present invention relates to a method, a system, modules and a program for associating a callback number with a voice message.

The callback number associated with the recorded voice message allows a call automaton to automatically call this number without it being necessary to key it in manually. Hence, the possibility of automatically keying in the callback number can be offered to the telephone subscriber who consults this voice message.

Existing methods of associating a callback number with a voice message recorded by the caller on the answering machine of the subscriber all comprise a step of acquiring the callback number to be associated with the voice message recorded.

For this purpose, at the end of the recording of the voice message, the existing methods offer the caller the possibility of pressing a key on the keypad of his telephone to trigger this step of acquisition of the callback number. Moreover, in the existing methods, the caller thus keys the number on which he wishes to be called back into the keypad of his telephone. The depressing of each key of the keypad causes the emission of a DTMF (Dual Tone Multi Frequency) tone which makes it possible to recognize the key depressed and hence, ultimately, the callback number keyed in by the caller.

This callback number is then recorded in a format appropriate for use by the call automaton during the consultation of the voice message by the subscriber.

This method is satisfactory. However, the ergonomics thereof are worth improving so as to facilitate the implementation thereof in respect of the caller.

The invention is therefore aimed at proposing a method that is simpler to implement for associating a callback number with a voice message recorded on the answering machine of a telephone subscriber.

The subject of the invention is therefore such a method comprising:
as the caller speaks the voice message to be recorded, a step of continuous and real-time comparison of the natural language expressions contained in the voice message spoken with one or more predefined natural language expressions contained in a first pre-recorded dictionary, this first dictionary containing only a limited number of natural language expressions relative to the whole set of possible natural language expressions, and
in case of correspondence between the expression spoken by the caller and the or one of the predefined expressions contained in the first dictionary, a step of acquiring the callback number to be associated with the voice message recorded is immediately triggered.

By virtue of the above method, it is no longer necessary for the caller to depress a key of the keypad of his telephone to trigger the acquisition step. In particular, this acquisition step may now be triggered from a keypad-less telephone.

Moreover, the acquisition step can be triggered at any moment in the course of the recording of the voice message without it being necessary to wait until the end of this voice message.

Thus, the above method facilitates for the caller the associating of a callback number with the voice message that he records on the answering machine of the subscriber and therefore improves the ergonomics of the method.

Finally, the fact that the first dictionary contains only a limited number of expressions, makes it possible to trigger the callback number acquisition step only in response to the speaking of certain key words or expressions. This facilitates and also accelerates the voice recognition of the predefined expression or expressions.

The embodiments of this method may comprise one or more of the following characteristics:
the acquisition step consists in continuously comparing in real time the natural language expressions contained in the rest of the voice message spoken with one or more predefined natural language expressions contained in a second pre-recorded dictionary, this second dictionary being different from the first dictionary and containing only a limited number of natural language expressions relative to the whole set of possible natural language expressions;
this method comprises:
   a step of broadcasting by a voice synthesis module of the callback number acquired in an audible manner by the caller, then
   a step of acquisition at the caller end of an instruction of confirmation or of denial of the correctness of the callback number broadcast, then
   a step of association of the callback number acquired with the voice message recorded only if a confirmation instruction has been acquired.

These embodiments of the method of associating a callback number with a voice message furthermore exhibit the following advantages:
the voice recognition of the callback number with the aid of the second dictionary facilitates and accelerates this voice recognition of the callback number since the natural language expressions of the voice message are compared with only a limited and reduced number of predefined expressions. The voice recognition also improves the ergonomics of the method by rendering it useable from keypad-less telephones;
the broadcasting of the callback number acquired followed by the acquisition of an instruction of confirmation or denial makes it possible to avoid associating an incorrect callback number with the voice message recorded.

The subject of the invention is also a system of associating a callback number with a voice message recorded by a caller on the answering machine of a called telephone subscriber, the associated callback number being useable by a call automaton to automatically call this callback number without it being necessary to key it in manually, this system comprising a first module for acquisition of the callback number to be associated with the voice message recorded. This system comprises:
a first pre-recorded dictionary of predefined natural language expressions, this first dictionary containing only a limited number of natural language expressions relative to the whole set of possible natural language expressions, and
a comparison module able to
   compare continuously and in real time the natural language expressions contained in the voice message spoken by the caller with one or more predefined expressions contained in the first dictionary, and
   to immediately trigger the activation of the acquisition module in case of correspondence between the expression spoken by the caller and one of the predefined expressions contained in the first dictionary.

The embodiments of this system for associating a callback number with a voice message may comprise one or more of the following characteristics:
a second pre-recorded dictionary of predefined natural language expressions, this second dictionary being different from the first dictionary and containing only a limited number of natural language expressions relative to the whole set of possible natural language expressions, and the acquisition module is able to continuously compare in real time the natural language expressions contained in the rest of the voice message spoken by the caller with one or more predefined expressions contained in the second pre-recorded dictionary, so as to acquire the callback number;
the first comparison module and the acquisition module are embodied with the aid of one and the same voice recognition module configurable so as to use, alternately, the first and second dictionaries.

The subject of the invention is also a comparison module, a voice recognition module and a computer program for the implementation of the method and of the system above.

The invention will be better understood on reading the description which follows, given merely by way of example and while referring to the drawings in which:

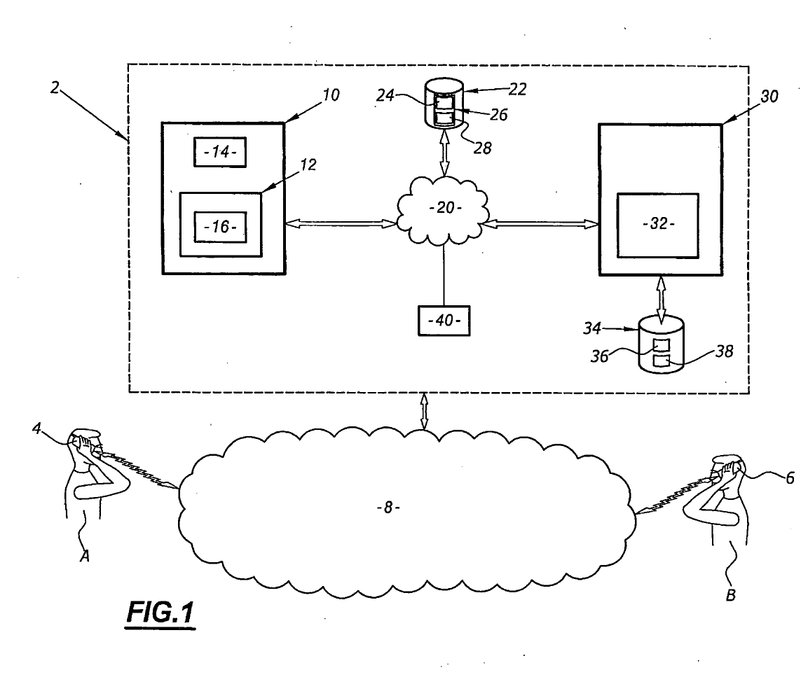

FIG. 1 is a diagrammatic illustration of the architecture of a system for associating a callback number with a voice message; and

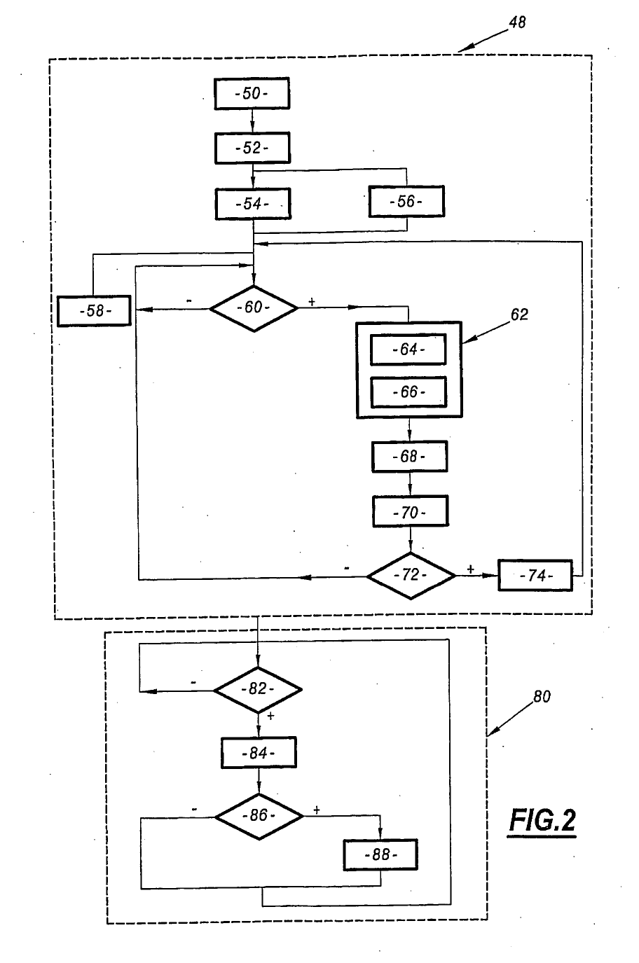

FIG. 2 is a flow chart of a method of associating a callback number with a voice message implemented in the system of FIG. 1.

FIG. 1 represents a system 2 for associating a callback number with a voice message recorded by a caller A on the answering machine of a telephone subscriber B.

To simplify FIG. 1, only the caller A and the subscriber B have been represented. However, the system 2 is useable by a multiplicity of callers and subscribers.

The caller A and the subscriber B are equipped with telephones, respectively 4 and 6, fixed or mobile.

The telephones 4 and 6 are hooked up to an information transmission network 8. The network 8 is, for example a telephone network, such as a mobile telephony network or a fixed telephony network. The system 2 is also hooked up to the network 8.

The network 8 is able to redirect a call destined for the telephone 6 to the system 2 in case of absence of response on the part of the subscriber B.

The system 2 comprises a voice messaging server 10 able to record in a voice box, a voice message left by the caller A in case of absence of response of the subscriber B. The server 10 also allows the consultation of the voice box by the subscriber B so that the latter can take cognisance of the voice messages which have been recorded during his absence, for example. Thus, the server 10 fulfils the function of answering machine for the subscriber B and also for a large number of other subscribers.

In this embodiment, the server 10 is equipped:
with a module 12 for broadcasting announcements, and
with a module 14 for voice recognition comprising its own dictionary.

The module 12 is equipped with a sub-module 16 for voice synthesis of a telephone number.

The server 10 is hooked up by way of a local network 20 to information storage means 22 in which are recorded the voice messages. For example, the voice messages are recorded in a field 24 of a voice box 26. The voice box 26 also comprises a field 28 for storing a callback number associated with the voice message recorded in the field 24.

The system 2 is also equipped with a computer platform 30 for extracting a callback number. This platform 30 comprises a configurable voice recognition module 32. This module 32 is hooked up to a memory 34 comprising two dictionaries 36 and 38 of predefined natural language expressions. The modules 32 and 14 may have a common physical representation or on the contrary be physically distinct.

The dictionary 36 contains only natural language expressions suitable for triggering the acquisition of a callback number. By way of example, the dictionary 36 comprises the following two expressions: “Can you call me back on . . .” and “Call me back on . . .”.

The dictionary 38 contains predefined natural language expressions corresponding either to the numbers making up a callback telephone number or to references of contacts of an address book. These predefined expressions correspond, for example, to numerical values lying between 0 and 999 or to names such as surnames, first names, company names, etc. contained in the address book. The address book associates a callback telephone number with each contact reference. The address book is pre-recorded.

The module 32 is configurable to use alternately the dictionary 36 and the dictionary 38. When the module 32 is configured to use the dictionary 36, this module 32 is used in the guise of comparison module able to continuously compare in real time natural language expressions contained in the voice message spoken by the caller A, with predefined expressions contained in the dictionary 36. In this mode of operation, the module 32 is able to immediately trigger the activation of a module for acquiring the callback number in case of correspondence between an expression contained in the voice message and one of those contained in the dictionary 36.

When the module 32 is configured to use only the dictionary 38, this module 32 is used in the guise of acquisition module able to continuously compare in real time the natural language expressions contained in the voice message with the predefined expressions contained in the dictionary 38 so as to acquire the callback number.

Typically, the server 10 and the platform 30 are embodied on the basis of programmable electronic processors able to execute instructions recorded on an information recording medium. For this purpose, the memory 34 comprises instructions for the execution of the method of FIG. 2 when these instructions are executed by the platform 30.

Finally, the system 2 also comprises a call automaton 40 able to key in the callback number recorded in the field 28 in response to a command from the subscriber B. The automaton 40 is hooked up to the network 20.

The manner of operation of the system 2 will now be described with regard to the method of FIG. 2.

Initially, a phase 48 of recording a voice message is executed. During a step 50, the caller A calls the subscriber B. It is assumed here that the subscriber B is absent or not contactable, that is to say he does not respond to the call of A.

After a certain number of rings during a step 52, the network 8 redirects the call of A to the system 2 and, more precisely, to the server 10.

In response to this call, the server 10 goes off-hook and the module 12 broadcasts, during a step 54, a voice announcement indicating to the caller A the possibility of leaving a voice message as well as the possibility of recording a callback number at any moment in the message by speaking one of the predefined expressions contained in the dictionary 36.

In parallel, during a step 56, the platform 30 configures the module 32 so as to compare the expressions of the voice message which will be spoken by the caller A only with the expressions contained in the dictionary 36.

Thereafter, during a step 58, the server 10 begins to record the voice message spoken by the caller A in the field 24 of the voice box 26.

In parallel, during a step 60, as the caller A speaks a voice message to be recorded, the module 32 compares the natural language expressions contained in this voice message currently being spoken with the expressions contained in the dictionary 36.

As long as no natural language expression spoken by the caller A corresponds to one of those contained in the dictionary 36, step 60 continues.

As soon as one of the natural language expressions spoken by the caller A corresponds to one of the expressions contained in the dictionary 36, then the module 32 proceeds immediately to a step 62 of acquisition of the callback number.

At the start of step 62, during an operation 64, the platform 30 configures the module 32 so that the latter compares the following expressions of the voice message only with the expressions contained in the dictionary 38.

Thereupon, during an operation 66, each time the caller A speaks a digit of his callback number, the latter is compared with the expressions contained in the dictionary 38 so as to identify the digit spoken. Each time a digit is identified, the latter is converted into a numerical character to form the callback number. In a variant, it is also possible to identify phonemes spoken so as to form the name of a contact to be called back. In this case, the telephone number used to call the latter back will be that associated with the name of the contact contained in the address book.

Once the entirety of the callback number has been acquired (or the entirety of the name of the contact to be called back) the callback number is transmitted, during a step 68 of the module 12 of the messaging server 10.

In response, to the receipt of this callback number in the form of numerical characters, the module 12 broadcasts, during a step 70, a voice announcement audible by the caller A. For example, this voice announcement is the following: “You will be called back on [telephone number]. If this number is correct say “yes”. If you want to modify the callback number say the new number after the bleep. If you want to cancel the callback number that you have left say “cancel””. The part between square brackets of the above message is automatically replaced with the voice synthesis of the callback number transmitted during step 68.

Thereafter, during a step 72, the module 14 acquires an instruction of confirmation or of denial or else a new callback number dictated by the caller A. This step 72 of acquisition is carried out by voice recognition of the response of the caller A.

If no response is acquired during a determined time interval, or if the response acquired is “cancel”, then the method returns to step 60.

In the converse case, during a step 74, the server 10 records, in the field 28 of the voice box 26, the callback number transmitted during step 68 if the response spoken by the caller is “yes” or a new callback number spoken after the bleep. In this way, the callback number is associated with the voice message recorded.

Thereafter, the caller A may continue the recording of his voice message which is recorded in the field 24.

When the subscriber B wants to consult his messaging, he proceeds to a message consultation phase 80.

During this phase 80, the caller B connects up by way of his telephone 6 to the server 10.

The server 10 then verifies, during a step 82, whether the message that the subscriber B wants to consult is associated with a callback number. For example, the server 10 verifies that the field 28 associated with the message recorded in the field 24 is not empty.

In the affirmative, after the subscriber B has finished listening to the message contained in the field 24, the module 12 broadcasts, during a step 84 a voice announcement prompting him to automatically call back the callback number associated with this message.

During a step 86, the instructions of the subscriber B are acquired. For example, the response is acquired and recognized with the aid of the voice recognition module 14.

If the subscriber wants to automatically call back the callback number, then, the call automaton 40, during a step 88, automatically keys in the callback number associated with the message so as to set up a telephone link to the caller A. Henceforth, the subscriber B does not need to manually key this number into the keypad of his telephone 6.

In the case where the subscriber does not want to automatically call back the callback number, the step 88 is short-circuited.

Steps 82 to 88 are iteratively repeated for each message recorded in the voice box of the subscriber B.

Numerous other embodiments of the method and of the system of associating a callback number with a voice message are possible. For example, steps 70, 72 and 74 are performed only at the end of the recording of the voice message and no longer while the voice message is being recorded.

The server 10, the platform 30 and the automaton 40 have been described here in the particular case where these elements correspond to distinct physical entities. As a variant, these various elements are grouped together within one and the same computer server or on the contrary, implemented in a multitude of computer servers.

The system 2 has been described in the particular case where the messaging server 10 is common to a multitude of subscribers. As a variant, the whole set of elements of the system 2 are incorporated into an autonomous telephone answering machine dedicated to a subscriber, this answering machine then being installed at the subscriber end and hooked up to his telephone line.

As a variant, the comparison module and the acquisition module are obtained on the basis of distinct technological bricks and no longer by configuring the voice recognition module 32 in a different way. For example, the comparison module is embodied on the basis of a first voice recognition module while the acquisition module is embodied on the basis of another voice recognition module distinct from the first voice recognition module.

Finally, it will be noted that the callback number associated with the voice message is unoccupied and in particular that it does not necessarily correspond to the telephone number of the telephone 4. However, the format of the number must correspond to that of a telephone number.

1. Method of associating a callback number with a voice message recorded by a caller on the answering machine of a called telephone subscriber, the associated callback number being useable by a call automaton to automatically call this callback number without it being necessary to key it in manually, wherein this method comprises,
as the caller speaks the voice message to be recorded, a step of continuous and real-time comparison of the natural language expressions contained in the voice message spoken with one or more predefined natural language expressions contained in a first pre-recorded dictionary, this first dictionary containing only a limited number of natural language expressions relative to the whole set of possible natural language expressions, and
in case of correspondence between the expression spoken by the caller and the or one of the predefined expressions contained in the first dictionary, a step of acquiring the callback number to be associated with the voice message recorded is immediately triggered, and
wherein the acquisition step consists in continuously comparing in real time the natural language expressions contained in the rest of the voice message spoken with one or more predefined natural language expressions contained in a second pre-recorded dictionary, this second dictionary being different from the first dictionary and containing only a limited number of natural language expressions relative to the whole set of possible natural language expressions.

2. Method according to claim 1, in which this method comprises:
a step of broadcasting by a voice synthesis module, of the callback number acquired in an audible manner by the caller, then
a step of acquisition at the caller end of an instruction of confirmation or of denial of the correctness of the callback number broadcasted, then
a step of association of the callback number acquired with the voice message recorded only if a confirmation instruction has been acquired.

3. System of associating a callback number with a voice message recorded by a caller on the answering machine of a called telephone subscriber, the associated callback number being useable by a call automaton to automatically call this callback number without it being necessary to key it in manually, this system comprising a first module for acquisition of the callback number to be associated with the voice message recorded, wherein the system comprises:
a first pre-recorded dictionary of predefined natural language expressions, this first dictionary containing only a limited number of natural language expressions relative to the whole set of possible natural language expressions, and
a comparison module able to
compare continuously and in real time the natural language expressions contained in the voice message spoken by the caller with one or more predefined expressions contained in the first dictionary, and
to immediately trigger the activation of the acquisition module in case of correspondence between the expression spoken by the caller and one of the predefined expressions contained in the first dictionary, and
a second pre-recorded dictionary of predefined natural language expressions, this second dictionary being different from the first dictionary and containing only a limited number of natural language expressions relative to the whole set of possible natural language expressions, and
wherein the acquisition module is able to continuously compare in real time the natural language expressions contained in the rest of the voice message spoken by the caller with one or more predefined expressions contained in the second pre-recorded dictionary, so as to acquire the callback number.

4. System according to claim 3, wherein the first comparison module and the acquisition module are embodied with the aid of one and the same voice recognition module configurable so as to use, alternately, the first and second dictionaries.

5. Comparison module adapted to be implemented in a system in accordance with claim 3, wherein the comparison module is able to,
compare continuously and in real time the natural language expressions contained in the voice message spoken by the caller with one or more predefined expressions contained in the first dictionary, and
to immediately trigger the activation of the acquisition module in case of correspondence between the expression spoken by the caller and the or one of the predefined expressions contained in the first dictionary.

6. Voice recognition module adapted so as to be implemented in a system in accordance with claim 4, wherein this module is configurable to use alternately a first and a second dictionary of predefined natural language expressions each containing only a limited number of natural language expressions relative to the whole set of possible natural language expressions, in such a way as to alternately form respectively the module for continuous and real time comparison of the natural language expressions contained in the voice message spoken by the caller with one or more predefined expressions contained in the first dictionary, and the acquisition module suitable for continuously comparing in real time natural language expressions contained in the rest of the voice message with one or more predefined expressions contained in the second pre-recorded dictionary, the first comparison module being able to immediately trigger the activation of the acquisition module in case of correspondence between the expression spoken by the caller and one of the predefined expressions contained in the first dictionary.

7. Computer program, wherein this computer program comprises instructions for the execution of a method in accordance with claim 1, when these instructions are executed by an electronic computer.

8. Computer program, wherein this computer program comprises instructions for the execution of a method in accordance with claim 2, when these instructions are executed by an electronic computer.
